(19) United States
(12) Patent Application Publication
(10) Pub. No.: US 2007/0156865 A1
(43) Pub. Date: Jul. 5, 2007

(54) Method and apparatus for downloading an operating system or an application in cdma system

(75) Inventors: Woo Young Yang, Gyeonggi-do (KR); Moon Seok Baek, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Korea Limited

(21) Appl. No.: 10/556,272

(22) PCT Filed: Jun. 2, 2004
(86) PCT No.: PCT/KR04/01312

§ 371 Date: Nov. 7, 2006

(30) Foreign Application Priority Data
Jun. 2, 2003 (KR) 10-2003-0035287

(51) Int. Cl. G06F 15/173

(52) U.S. Cl. 709/223

(57) ABSTRACT

The present invention is directed to a method and apparatus for downloading an operating system (OS) or an application and installing it on a set of base station controllers (BSCs) in a CDMA mobile communication system. According to the present invention, when a newer version of an OS or application needs to be installed on the set of BSCs, each of the BSCs is informed of the need for updating an OS or application by the base station manager (BSM), and simultaneously downloads the OS or application from the BSM for installation. This may diminish the traffic overload between the BSM and the BSCs by reducing the number of additional control signals communicated when the BSCs individually download the OS or application.

### TECHNICAL FIELD

The present invention is directed to a method and apparatus for downloading an operating system (OS) or an application (AP) in a CDMA system. More particularly, the present invention is directed to a method and apparatus for downloading an OS or an AP and installing it on a set of base station controllers (BSCs) in a CDMA system by downloading a unified OS and AP from a base station manager (BSM) to all BSC processors. According to the present invention, the traffic overload between the BSM and the BSCs can be diminished by reducing the number of additional control signals communicated when the BSCs individually download the OS or application.

### BACKGROUND ART

Generally, the system industry requires new functions and high-speed systems to keep pace with rapid technical advances and to accommodate customers' requests. To meet these requirements, higher speed cores are needed, or cores and device drivers supplemented with additional functions are necessary.

If the cores for performing the same function in the same system are different, then the boards inform and request the BSM for OSs and APs corresponding to the cores. The BSM manages the OSs and APs for each core, and transmits the OS and AP to the respective core, if requested.

However, since this procedure is a load for the BSM and BSC processors, Over Load Job may undesirably occur during the operation of the system.

### DISCLOSURE OF THE INVENTION

The object of the present invention is to provide a method and apparatus for downloading a unified OS from a BSM and installing the same on a BSC in a CDMA communication system in order to decrease the load caused by the signals communicated between a BSM and a BSC processor. This is achieved by downloading a unified OS and AP from the BSM to all BSC processors when the OS and AP of a BSC board are updated by making each BSC processor, which receives the unified OS and AP, update its OS and AP selectively.

To accomplish such object, there is provided an apparatus for downloading a unified operating system (OS) or application (AP) from a base station manager (BSM) and installing the same on a base station controller (BSC) in a CDMA communication system, the apparatus comprising:

a BSM for uploading the unified OS or AP stored in an RAM disk of the BSM; and

a BSC processor for downloading the unified OS or AP from the BSM, for selectively reading a corresponding part of the downloaded unified OS or AP by checking an Electrically Erasable and Programmable Read Only Memory (EEPROM) having board information pre-stored therein, and for storing the selected OS and AP in an Embedded Programmable Logic Device (EPLD).

Further, to accomplish such object, there is provided a method for downloading a unified operating system (OS) from a base station manager (BSM) and installing the same on a base station controller (BSC) in a CDMA communication system, the method comprising the steps of:

at the BSM, generating and transmitting a request signal to start downloading the unified OS to the BSC;

at the BSM, determining whether a response to the request is received from the BSC;

at the BSM, upon receipt of the response, uploading the unified OS, including a R1 type of OS and a R2 type of OS, stored in an RAM disk of the BSM to the BSC;

at the BSC, comparing a version of the downloaded unified OS with a version of an OS stored in an EEPROM of the BSC;

at the BSC, if the version of the downloaded unified OS is a newer one than the version of the BSC's OS, then determining whether a type of the BSC's OS is R1 or R2; and

if the type of the BSC's OS is R1, selectively reading an R1 part of the downloaded unified OS and installing the same on the BSC.

Also, to accomplish such object, there is provided a method for downloading a unified application (AP) from a base station manager (BSM) and installing the same on a base station controller (BSC) in a CDMA communication system, the method comprising the steps of:

at the BSM, generating and transmitting a request signal to start downloading the unified AP to the BSC;

at the BSM, determining whether a response to the request is received from the BSC;

at the BSM, upon receipt of the response, uploading the unified AP, including an R1 type of AP and an R2 type of AP, stored in an RAM disk of the BSM to the BSC;

at the BSC, determining whether a type of the BSC's AP is R1 or R2; and

at the BSC, if the type of the BSC's AP is R1, selectively reading an R1 part of the downloaded unified AP and installing the same on the BSC.

### BRIEF DESCRIPTION OF DRAWINGS

FIG. 1 shows an OS structure used in a method and apparatus for downloading a unified OS from a BSM and installing the same on a BSC in a CDMA communication system in accordance with one embodiment of the present invention.

FIG. 2 shows an AP structure used in a method and apparatus for downloading a unified OS from a BSM and installing the same on a BSC in a CDMA communication system in accordance with one embodiment of the present invention.

FIG. 3 shows a functional block diagram illustrating an apparatus for downloading a unified OS and AP from a BSM and installing the same on a BSC in a CDMA communication system in accordance with one embodiment of the present invention.

FIG. 4 shows a flow chart illustrating a method for downloading a unified OS from a BSM and installing the same on a BSC in a CDMA communication system in accordance with one embodiment of the present invention.

FIG. 5 shows a flow chart illustrating a method for downloading a unified AP from a BSM and installing the same on a BSC in a CDMA communication system in accordance with one embodiment of the present invention.

### BEST MODE FOR CARRYING OUT THE INVENTION

A method and apparatus for downloading a unified OS from a BSM and installing the same on a BSC in a CDMA communication system in accordance with one embodiment of the present invention is described below, together with the drawings.

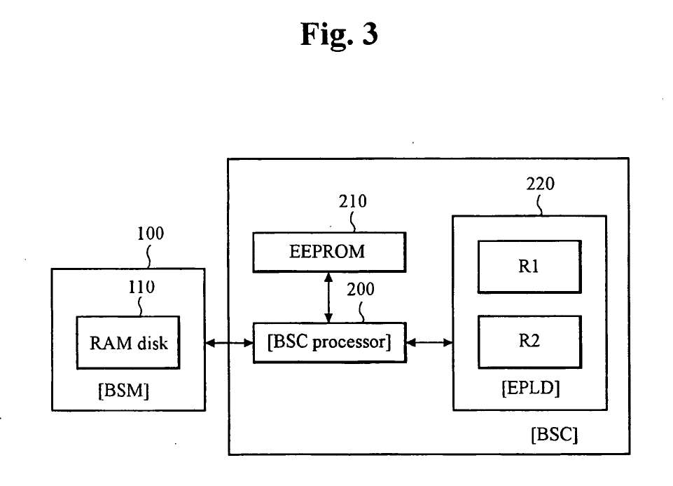

FIG. 3 shows a functional block diagram illustrating an apparatus for downloading a unified OS and AP from a BSM and installing the same on a BSC in a CDMA communication system in accordance with one embodiment of the present invention. According to one embodiment of the present invention, an apparatus for downloading a unified OS and AP from a BSM and installing the same on a BSC in a CDMA communication system comprises BSM 100 having RAM disk 110 and BSC processor 200 having Electrically Erasable and Programmable Read Only Memory (EEPROM) 210 and Embedded Programmable Logic Device (EPLD) 220.

BSM 100 downloads a unified OS and AP stored in RAM disk 110 to BSC processor 200 in a batch.

BSC processor 200 downloads the unified OS and AP from BSM 100, selectively reads from the unified OS and AP a desired OS or AP via EEPROM 210 pre-storing board information, and stores the desired OS or AP in EPLD 220.

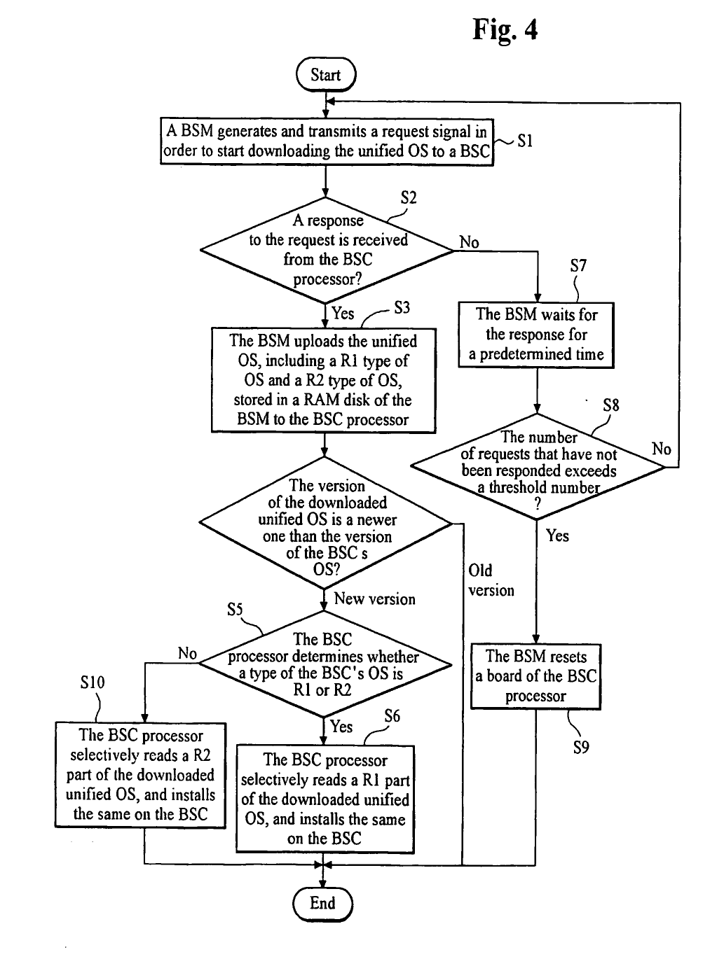

Referring to FIG. 4, a method for downloading a unified OS from a BSM and installing the same on a BSC in a CDMA communication system in accordance with one embodiment of the present invention is now described.

First, BSM 100 generates a request signal in order to start downloading the unified OS and transmits the signal to BSC 200 (S1).

Then, BSM 100 determines whether a response to the request is received from BSC processor 200 (S2).

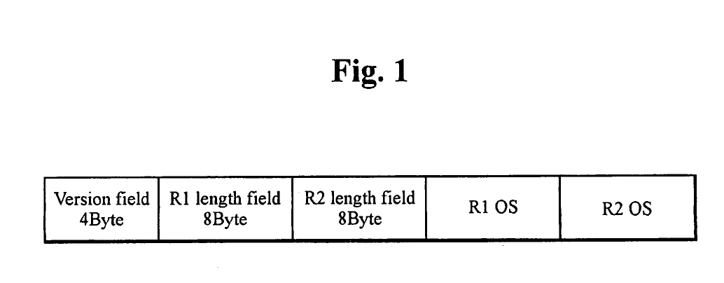

Upon receipt of the response, BSM 100 uploads the unified OS, including a R1 type of OS and a R2 type of OS, stored in RAM disk 110 of BSM 100 to BSC processor 200 (S3). As shown in FIG. 1, the unified OS transmitted from BSM 100 to BSC processor 200 comprises a 4 byte field indicating version information, an 8 byte field indicating length information of the R1 OS, an 8 byte field indicating length information of the R2 OS, a R1 OS and a R2 OS.

BSC processor 200 compares a version of the downloaded unified OS with a version of an OS stored in EEPROM 210 of the BSC. This determines whether the version of the downloaded unified OS is a newer one than the version of the BSC's OS (S4).

Unless the version of the downloaded unified OS is a newer one than the version of the BSC's OS, the method is completed. Otherwise, BSC processor 200 determines whether a type of the BSC's OS is R1 or R2 by reading EEPROM 210 (S5).

If the type of the BSC's OS is R1, then BSC processor 200 selectively reads a R1 part of the downloaded unified OS, stores the R1 type OS to EPLD 220, and installs the same on the BSC (S6).

On the other hand, at the step S2, if the response to the request has not been received from BSC processor 200, then BSM 200 sets a waiting time to one second and waits for the response to the waiting time (S7).

Next, BSM 100 determines whether the number of requests that have not been responded by BSC processor 200 exceeds a threshold number (e.g., twenty) (S8).

If the number of requests does not exceed the threshold number, then the method returns to the step S1. Otherwise, BSM 100 resets a board of BSC processor 200 (S9).

On the other hand, at the step S5, if the type of the BSC's OS is R2, then BSC processor 200 selectively reads a R2 part of the downloaded unified OS, stores the R2 type OS to EPLD 220, and installs the same on the BSC (S10).

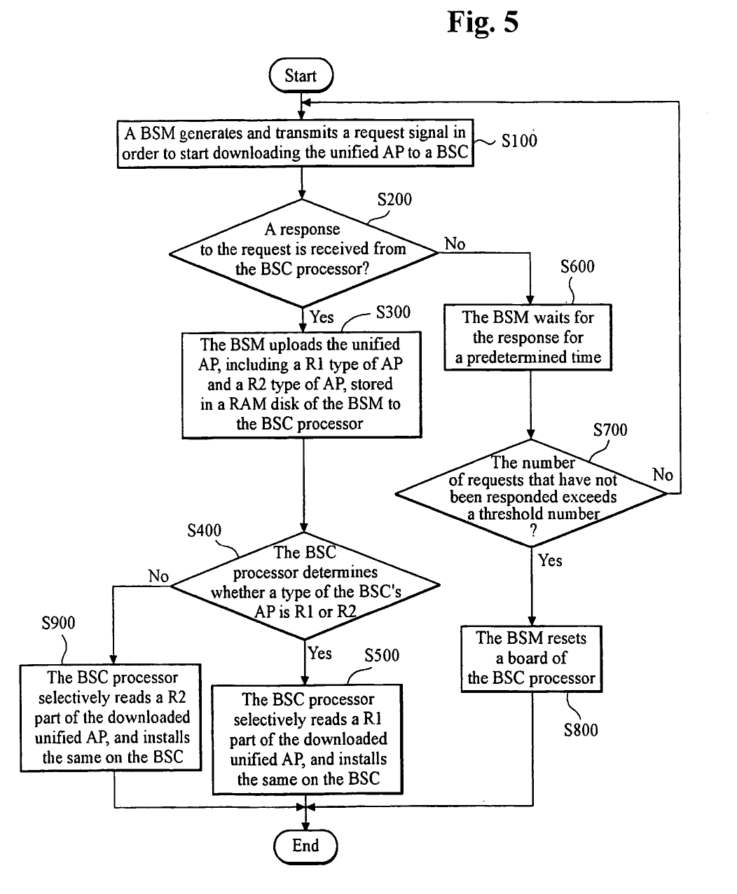

Referring to FIG. 5, a method for downloading a unified AP from a BSM and installing the same on a BSC in a CDMA communication system in accordance with other embodiment of the present invention is now described.

First, BSM 100 generates a request signal to start downloading the unified AP and transmits the signal to BSC 200 (S100).

Then, BSM 100 determines whether a response to the request is received from BSC processor 200 (S200).

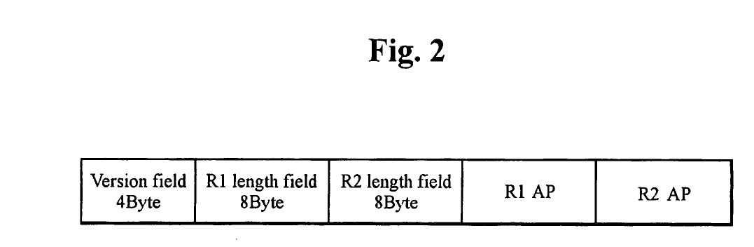

Upon receipt of the response, BSM 100 uploads the unified AP, including a R1 type of AP and a R2 type of AP, stored in RAM disk 110 of BSM 100 to BSC processor 200 (S300). As shown in FIG. 2, the unified AP transmitted from BSM 100 to BSC processor 200 comprises a 4 byte field indicating version information, an 8 byte field indicating length information of the R1 AP, an 8 byte field indicating length information of the R2 AP, a R1 AP and a R2 AP.

BSC processor 200 determines whether a type of the BSC's AP is R1 or R2 by reading EEPROM 210 (S400).

If the type of the BSC's OS is R1, then BSC processor 200 selectively reads a R1 part of the downloaded unified AP, stores the R1 type AP to EPLD 220, and installs the same on the BSC (S500).

On the other hand, at the step S200, if a response to the request has not been received from BSC processor 200, then BSM 200 sets a waiting time to one second and waits for the response to the waiting time (S600).

Next, BSM 100 determines whether the number of requests that have not been responded by BSC processor 200 exceeds a threshold number (e.g., twenty) (S700).

If the number of requests does not exceed the threshold number, then the method returns to the step 5100. Otherwise, BSM 100 resets a board of BSC processor 200 (S800).

On the other hand, at the step S400, if the type of the BSC's OS is R2, then BSC processor 200 selectively reads a R2 part of the downloaded unified AP, stores the R2 type AP to EPLD 220, and installs the same on the BSC (S900).

As described above, according to a method and apparatus for downloading an OS or an application and installing it on a set of BSCs in a CDMA system, an old model and a new model of an OS or AP can be downloaded simultaneously by unifying OSs of different processes into one. Also, in the event that different types of boards work the same function by using different types of OSs, the OSs can be installed without additional control signals with a BSM.

Since the present invention was described with respect to a particular embodiment of an apparatus for downloading an OS or an application and installing it on a set of BSCs in a CDMA system, it will be apparent to those skilled in the art that many changes and modifications may be made without departing from the scope of the invention as defined in the appended claims and those equivalent thereto.

1. An apparatus for downloading a unified operating system (OS) or application (AP) from a base station manager (BSM) and installing the same on a base station controller (BSC) in a CDMA communication system, the apparatus comprising:
a BSM for uploading the unified OS or AP stored in an RAM disk of the BSM; and
a BSC processor for downloading the unified OS or AP from the BSM, selectively reading a corresponding part of the downloaded unified OS or AP by checking an Electrically Erasable and Programmable Read Only Memory (EEPROM) having board information pre-stored therein, and storing the selected OS and AP in an Embedded Programmable Logic Device (EPLD).

2. A method for downloading a unified operating system (OS) from a base station manager (BSM) and installing the same on a base station controller (BSC) in a CDMA communication system, the method comprising the steps of:
at the BSM, generating and transmitting a request signal to start downloading the unified OS to the BSC;
at the BSM, determining whether a response to the request is received from the BSC;
at the BSM, upon receipt of the response, uploading the unified OS, including a R1 type of OS and a R2 type of OS, stored in an RAM disk of the BSM to the BSC;
at the BSC, comparing a version of the downloaded unified OS with a version of an OS stored in an EEPROM of the BSC;
at the BSC, if the version of the downloaded unified OS is a newer one than the version of the BSC's OS, determining whether a type of the BSC's OS is R1 or R2; and
if the type of the BSC's OS is R1, selectively reading an R1 part of the downloaded unified OS and installing the same on the BSC.

3. The method of claim 2, wherein the unified OS comprises a 4 byte field indicating version information, an 8 byte field indicating length information of the R1 OS, and an 8 byte field indicating length information of the R2 OS.

4. The method of claim 2, further comprising the steps of:
at the BSM, if the response to the request has not been received from the BSC, waiting for the response for a predetermined time;
at the BSM, determining whether the number of requests that have not been responded by the BSC exceeds a threshold number;
if the number of requests does not exceed the threshold number, returning to the step of generating and transmitting a request signal to start downloading the unified OS to the BSC; and
at the BSM, if the number of requests exceeds the threshold number, resetting a board of the BSC.

5. The method of claim 2, further comprising the step of:
if the type of the BSC's OS is R2, selectively reading a R2 part of the downloaded unified OS and installing the same on the BSC.

6. A method for downloading a unified application (AP) from a base station manager (BSM) and installing the same on a base station controller (BSC) in a CDMA communication system, the method comprising the steps of:
at the BSM, generating and transmitting a request signal to start downloading the unified AP to the BSC;
at the BSM, determining whether a response to the request is received from the BSC;
at the BSM, upon receipt of the response, uploading the unified AP, including a R1 type of AP and a R2 type of AP, stored in an RAM disk of the BSM to the BSC;
at the BSC, determining whether a type of the BSC's AP is R1 or R2; and
at the BSC, if the type of the BSC's AP is R1, selectively reading a R1 part of the downloaded unified AP and installing the same on the BSC.

7. The method of claim 6, wherein the unified AP comprises a 4 byte field indicating version information, an 8 byte field indicating length information of the R1 AP, and an 8 byte field indicating length information of the R2 AP.

8. The method of claim 6, further comprising the steps of:
at the BSM, if the response to the request has not been received from the BSC, waiting for the response for a predetermined time;
at the BSM, determining whether the number of requests that have not been responded by the BSC exceeds a threshold number;
if the number of requests does not exceed the threshold number, returning to the step of generating and transmitting a request signal to start downloading the unified AP to the BSC; and
at the BSM, if the number of requests exceeds the threshold number, resetting a board of the BSC.

9. The method of claim 6, further comprising the step of:
if the type of the BSC's AP is R2, selectively reading a R2 part of the downloaded unified AP and installing the same on the BSC.
